(19) United States
(12) Patent Application Publication
(10) Pub. No.: US 2026/0030005 A1
(43) Pub. Date: Jan. 29, 2026

(54) METHOD FOR TRANSFORMING AN ABSTRACT REPRESENTATION OF A TRAINED NEURAL NETWORK INTO PROGRAM CODE IN A TARGET LANGUAGE

(71) Applicant: Robert Bosch GmbH, Stuttgart (DE)

(72) Inventors: Sebastian Boblest, Duernau (DE); Duy Khoi Vo, Stuttgart (DE); Jan Eisenberg, Tuebingen (DE); Jens Stefan Buchner, Bietigheim-Bissingen (DE); Ulrik Hjort, Malmö (SE)

(21) Appl. No.: 18/997,984

(22) PCT Filed: Jul. 13, 2023
(86) PCT No.: PCT/EP2023/069465

§ 371 Date: Jan. 23, 2025

(30) Foreign Application Priority Data
Aug. 12, 2022 (DE) 10 2022 208 435.7

(51) Int. Cl. G06F 8/41; G06N 3/10

(52) U.S. Cl. CPC G06F 8/433; G06N 3/10

(57) ABSTRACT

A method for transforming an abstract representation of a trained neural network into program code in a target language. The program code is convertible into executable program code using a compiler for the target language. The method includes: reading an abstract representation of a neural network which has already been trained; calculating an intermediate representation of the neural network from the abstract representation, the intermediate representation specifying a computation graph; ascertaining a plurality of plan proposals for planning the memory usage during the execution of the computation graph; ascertaining a quality level for each plan proposal; selecting a plan proposal based on the ascertained quality level; and generating the sought program code in the target language from the intermediate representation and the selected plan proposal.

### FIELD

The present invention relates to a method for transforming an abstract representation of a trained neural network into program code in a target language, said program code being convertible into executable program code by means of a compiler for the target language. The present invention also relates to a computer program implementing an aforementioned method, to a machine-readable data carrier and/or to a download product having such a computer program, and to one or more computers and/or compute instances comprising the aforementioned computer program.

### BACKGROUND INFORMATION

Neural networks (NN) are graphs consisting of individual layers which are connected to one another via input-output relations. The simplest type is a sequential network, where the operators are arranged in a chain, and the current operator in each case receives data from its predecessor and passes further processed data to its successor. The corresponding data are temporarily stored in what are known as interbuffers. However, many NNs have a much more complex structure having branching paths which later merge again. In addition to the interbuffers for temporarily storing data which are exchanged between operators, buffers can also exist within operators in order to store intermediate results there. These are called intrabuffers. The size of interbuffers is determined by the network architecture. Intrabuffers, on the other hand, depend on the specific implementation of individual layers. This makes it possible to save computation time at the expense of additional memory consumption when using an intrabuffer.

When implementing NNs on computer hardware, memory must be provided for all buffers. In training frameworks, this task can be solved dynamically. If needed, new memory is allocated and the new buffer is stored there. During the installation on the application device, in particular in the embedded area, pre-allocated memory is used whenever possible. This is possible since the graph structure and the size of all buffers in NNs are completely fixed, with a few exceptions such as NMS layers or LSTMs, which process variable sequence lengths. Address planning of buffers can also be referred to as memory planning.

When an NN is implemented in C or a comparable language, a pre-calculated amount of memory is allocated and each buffer is assigned an address within this memory. This approach generally results in lower memory consumption than other approaches.

Minimizing memory requirements is a task which cannot be neglected when training on GPUs having many GB of RAM (random access memory). It becomes particularly essential when the trained NN is to be installed on embedded devices, which have very limited RAM.

The general memory planning problem is NP-hard. This means that it is not possible to find an efficient algorithm for this purpose in terms of “polynomially growing runtime.” Instead, approximations must be used, or exact approaches for smaller problems, or approaches which exploit typical properties of NNs.

### SUMMARY

Within the scope of the present invention, a method has been developed for transforming an abstract representation of a trained neural network into program code in a target language. The aforementioned program code is convertible into executable program code by means of a compiler for the target language. According to an example embodiment of the present invention, the method comprises at least the steps described below. In a first method step, an abstract representation of a neural network which has already been trained is read, wherein said abstract representation comprises at least the architecture and the parameters which are obtained from the training process and which characterize the behavior of the neural network. In a subsequent method step, an intermediate representation of the neural network is calculated from the abstract representation. Said intermediate representation specifies a computation graph for the output of the neural network. In a further method step, a plurality of plan proposals, which are used to plan the memory usage during the execution of the computation graph, are then ascertained. Furthermore, a quality level is ascertained for each plan proposal using at least one specified criterion. In a subsequent method step, a plan proposal is then selected from the plurality of the ascertained plan proposals on the basis of the ascertained quality level. The sought program code is then generated in the target language from the intermediate representation and the selected plan proposal.

A particular advantage of the method of the present invention described above and below is that the planning of memory usage is decoupled from the generation of code. This means that, when generating the program code in the target language, an intermediate representation is created first, which is then used to carry out the planning of an efficient, optimal memory usage in order then to resume code generation using a selected plan for memory usage. Different algorithms can be used to plan memory usage, and the plans developed using said algorithms can subsequently be compared to one another. This allows the selection of a memory plan which is optimally “tailored” to the device on which the program code is to be installed. This can be particularly beneficial when RAM is a valuable and limited resource. This is in particular the case for tiny microcontrollers on which a (suitable) neural network can be installed and subsequently operated, possibly by means of the method proposed here. Corresponding microcontrollers having very limited memory space can be used in vehicles, in household appliances, including washing machines and dishwashers, but also in power tools.

The generation of program code can be time-consuming; for example, compiling a neural network in C code can take 20 minutes or more, while the planning of memory usage can ideally be completed within a few seconds. At the same time, particularly advantageous memory usage is important for subsequent optimal use of the neural network on one or more terminal devices having limited memory volume. The most optimal use or utilization of the memory space on one or more terminal devices is ensured by “testing” a plurality of memory plans. At the same time, by splitting the method into generating program code and creating a plurality of plans for memory usage and selecting the most suitable memory plan for the given situation, the resource of time is “saved” or gained both during installation and during the later inference of the corresponding neural network.

The method of the present invention disclosed herein is aimed at installing trained networks on the target device for productive use. In this application, a compilation of the highest possible quality is of great value. A slightly longer computation time, which must be used during the installation process for the calculation and comparison of different plans for memory usage, for example in the range of a few minutes up to approximately an hour in extreme cases, can be easily accepted in order to obtain a high-quality compilation through this additional effort.

According to an exemplary embodiment of the present invention, the plan proposals are ascertained using a plurality of different predetermined memory planning algorithms. Additionally or alternatively, the plan proposals can be ascertained using a parameterized approach with a plurality of different values of the free parameters.

In this way, the method of the present invention is in particular flexible with regard to the type of algorithms used to ascertain suitable memory plans. Instead of using one or a few sophisticated algorithms, a large number of algorithms can be used in the method proposed here. Among the large number of algorithms, there may be a simple but possibly very fast algorithm which directly finds an optimal solution in some cases but fails in other cases, possibly due to the complexity of the corresponding memory planning problem on a given terminal device. Furthermore, among the large number of algorithms, there may be algorithms whose approach consists of different approximation methods, including very complex but more time-consuming approximation methods. The method described above and below makes it possible to execute (in particular in parallel) a wide variety of approaches to memory planning and to compare the different results ascertained.

In the method of the present invention described above and below, it is not critical to use algorithms which find an optimal solution in some cases but fail in many other cases. If an algorithm cannot ascertain a solution, for example not within a given time or because the heuristic underlying the algorithm fails in a specific case for the given problem, the memory plan of another algorithm can be used.

On the other hand, it is also possible that a plan proposal already ascertained in the method already has a quality level which at least exceeds a predeterminable quality limit, or, depending on the definition of the level, falls below it, and can therefore already be regarded as sufficiently “good.” In this case, it can be provided that the ascertainment of further plan proposals for memory planning is interrupted or aborted, and the method continues with the generation of the sought program code in the target language from the intermediate representation and the plan proposal which has already been ascertained and the quality level of which exceeds (or falls below) the quality limit. In this way, the total installation time can be reduced while at the same time ensuring high quality of the compilation to be generated.

According to a further exemplary embodiment of the present invention, at least one plan proposal includes dynamically assigning memory space for a flexible portion of the intermediate results generated during the execution of the computation graph, and subsequently releasing said memory space.

Different algorithms which provide corresponding plan proposals can pursue different goals at this point. The primary goal is always to use the lowest possible total memory volume for all buffers. However, algorithms can, for example, deliberately ignore smaller buffers in the plan in order to better solve the remaining planning problem. Furthermore, additional algorithms can pursue different approximation solutions, etc.

In general, the plan proposals for subsequent memory usage assign an address within a predetermined, allocated memory (of the terminal device on which the inference is to take place) to each buffer provided in the structure of the neural network.

According to a further exemplary embodiment of the present invention, the quality level is a measure not only of the maximum total memory space requirement but also of the computational speed advantage achieved through unplanned intrabuffers, which are held in the registers of the CPU as a result.

According to one exemplary embodiment of the present invention, the computation graph of the neural network comprises transmitting intermediate results from a layer, or from an operator, of the neural network to a subsequent layer, or to a subsequent operator, of the neural network through an interbuffer. Furthermore or alternatively, the computation graph of the neural network can comprise temporarily storing intermediate results within a layer of the neural network in an intrabuffer for subsequent use in the same layer.

Within a neural network, intermediate results from one layer are passed to a later, subsequent layer. These intermediate results require interbuffers, which must ensure the storage of the corresponding data over a period of time until the calculation within the corresponding subsequent layer has been completed. Once the corresponding calculation in the subsequent layer is completed, the intermediate result no longer needs to be “kept” and the memory space previously assigned to this intermediate result can be released and rewritten. Furthermore, results within a layer must be temporarily stored for further calculations within that layer. For this purpose, there are intrabuffers which temporarily store the corresponding data until they are no longer needed and the corresponding memory space can also be released again in this case. In particular, the size of the memory requirement for the intrabuffers, and to a lesser extent also for the interbuffers, depends on the architecture of the terminal device on which the neural network is to be executed during inference. The method proposed here thus allows a flexible approach to the installation of a subsequently optimally executable neural network.

The memory planning should determine the addresses of the buffers in such a way that no buffer is overwritten as long as the corresponding data are still needed. For intrabuffers, this means that they may not be overwritten while the corresponding operator is computing. Interbuffers must be protected against overwriting from the moment the operator producing them as output starts computing until the last operator using them as input has finished its computation.

According to an exemplary embodiment of the present invention, one or more of the aforementioned memory planning algorithms in one of the aforementioned embodiments comprise at least the following steps: In one step, a global memory area having a predetermined size is provided. This size corresponds at least to MaxLB, wherein MaxLB corresponds to the maximally occurring combined memory requirement of all intermediate results whose simultaneous retention is still necessary at the time of execution of an operator. In a subsequent step, for each intermediate result, the smallest free memory area within the global memory area which can accommodate the intermediate result and is available for the necessary retention time of the intermediate result is selected. Furthermore, this smallest free memory area is assigned to the intermediate result for the necessary retention time. This type of assigning memory space can also be called “trivial memory planning.”

The aforementioned trivial memory planning approach can potentially compute an optimal solution for small NNs and for NNs having an advantageous structure.

According to a further exemplary embodiment of the present invention, one of the aforementioned algorithms of the plurality of predetermined algorithms comprises the optimization of N start addresses oᵢ, i=1, . . . , N, for intermediate results by means of integer linear programming. The i-th intermediate result has a memory requirement sᵢ and, in accordance with said memory requirement sᵢ, occupies a memory area in the memory between the start address oᵢ and an end address eᵢ. Furthermore, pairs (u, v) of intermediate results u and v whose simultaneous retention is necessary are stored in a conflict set C. The memory areas occupied by said intermediate results u and v must not overlap. The optimization of the N start addresses oᵢ, i=1, . . . , N, for intermediate results is then aimed at minimizing the highest resulting end address eᵢ.

As an alternative to the above exemplary embodiment, a global memory area having a predetermined size corresponding at least to MaxLB can in particular be provided. MaxLB corresponds to the combined storage requirement of all intermediate results whose simultaneous retention is still necessary at the time of execution of an operator. Furthermore, the start addresses oᵢ can then be optimized using the following equations:

$${e}_{i} = {o}_{i} + {s}_{i} ,$$

$$0 \leq {o}_{i} \leq MaxLB - {s}_{i} ,$$

$${o}_{u} \geq {e}_{v} or {o}_{v} \geq {e}_{u} , if ( u , v ) ∈ C .$$

Every solution of this system of equations is an optimal valid memory plan.

According to a further exemplary embodiment of the present invention, the exemplary embodiments mentioned above in which MaxLB is considered as the predetermined size of the memory area are varied if the optimization described above does not lead to a solution: In this case, the size of the global memory area considered can be increased to a value between MaxLB and 2*MaxLB.

According to a further exemplary embodiment of the present invention, one of the algorithms of the plurality of predetermined memory planning algorithms comprises at least the steps listed below. In a first step, the intermediate results which are expected to require the most memory space are ascertained. Additionally or alternatively, the layers of the neural network whose computation is expected to require the most memory space for intermediate results can be ascertained. In a subsequent step, an initial memory plan is first created for the aforementioned intermediate results, without taking into account the other intermediate results. This means that the aforementioned intermediate results and/or layers of the neural network ascertained in the first step, the computation of which is expected to require the most memory space for intermediate results, are placed in the global memory before memory space is assigned for the other intermediate results. This means that the “most voluminous” intermediate results or the intermediate results required in the layer having the greatest memory requirements are placed in the memory first or a memory area is assigned thereto first. Only thereafter, in a further step, are the remaining intermediate results placed using another memory planning algorithm.

This allows typical memory structures of existing NN architectures to be taken into account in a way which is particularly favorable for solving the memory planning problem.

For example, for creating the aforementioned initial memory plan and/or for placing the remaining intermediate results, the algorithm described above which carries out the steps for a “trivial memory planning” can be chosen.

According to a further exemplary embodiment of the present invention, the method proposed here furthermore comprises the following steps. In one method step, intermediate results which are not to be included in the memory planning but are to be dynamically stored on the stack are selected. In the following method steps, the plurality of memory planning algorithms is then executed only taking into account the intermediate results which are not to be stored on the stack.

This allows the problem of memory planning to be configured flexibly. Intermediate results can thus optionally be included in the memory planning or alternatively be allocated on the stack. This may increase the memory requirement but may improve the computation time since the CPU can hold arrays locally in the register.

According to a further example embodiment of the present invention, for debugging purposes, the plan proposals are ascertained under the additional boundary condition that a memory area once assigned for an intermediate result is not reused for another intermediate result.

In this case, all intermediate results of the individual layers as well as other auxiliary variables are available for analysis after one run of the NN. This means that all intermediate results of the individual layers and the values of the intrabuffers are preserved in the aforementioned embodiment and can be analyzed after an execution of the NN. Once the analysis is complete, it is then possible to “switch” to a memory-saving memory plan. However, in this case, it is in particular ensured that the result of the NN remains bit-for-bit identical.

According to a further exemplary embodiment of the present invention, the proposed method furthermore comprises the following steps. In one method step, the program code in the target language is converted into executable program code. In a subsequent method step, said executable program code is executed on at least one computer and/or on at least one compute instance in such a way that at least one input of the neural network is converted into at least one output of the neural network.

The present invention also relates to a computer program comprising machine-readable instructions which, when executed on one or more computers and/or compute instances, cause the computer(s) and/or compute instance(s) to perform one of the methods according to the present invention which are described above and below. The present invention also comprises a machine-readable data carrier and/or a download product on which the above computer program is stored, as well as a computer and/or compute instances equipped with the aforementioned computer program and/or the aforementioned machine-readable data carrier.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of a method according to the present invention.

FIG. 2A-2C show exemplary embodiments for sub-steps of the method according to FIG. 1.

### DETAILED DESCRIPTION OF EXAMPLE EMBODIMENTS

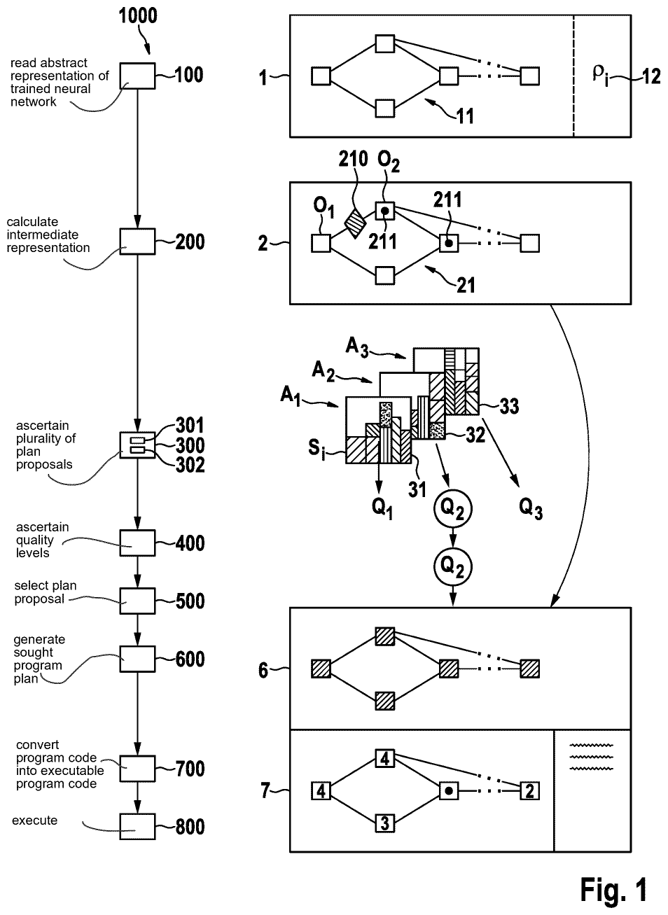

FIG. 1 shows an exemplary embodiment of a method 1000 for transforming an abstract representation 1 of a neural network which has already been trained into program code 6 in a target language. Said program code 6 is convertible into executable program code 7 by means of a compiler for the target language. As part of the method 1000, an abstract representation 1 of a neural network which has already been trained is read in step 100. The abstract representation 1 comprises at least the architecture 11 and the parameters 12, ρᵢ, which are obtained from the training process of the neural network and which characterize the behavior of the neural network. In step 200, an intermediate representation 2 of the neural network is then calculated from the abstract representation 1. Intermediate representation 1 specifies at least one computation graph 21 for the output of the neural network. Subsequently, in step 300, a plurality of plan proposals 31, 32, 33 for planning the memory usage during the execution of the computation graph 21 are ascertained. In step 400, a quality level Q1, Q2, Q3 for each plan proposal 31, 32, 33 is ascertained using at least one specified criterion. For example, the quality level, Q1; 02; 03, can be a measure of the maximum total memory requirement during the execution of the computation graph 21. In step 500, a plan proposal, 31; 32; 33, is then selected on the basis of the ascertained quality levels Q1, Q2 and Q3. In method step 600, the sought program code 6 is generated in the target language from the intermediate representation 21 and the selected plan proposal, Q2.

The plan proposals 31, 32, 33 ascertained in step 300 can be ascertained using a plurality of different predetermined memory planning algorithms, A1, A2, A3, and/or using a parameterized approach with a plurality of different values of the free parameters. At least one of the plan proposals, 31, 32, 33, can involve dynamically assigning memory space Sᵢ for intermediate results arising during the execution of the computation graph 21, and subsequently releasing said memory space.

The computation graph 21 of the neural network outlined in FIG. 1 comprises transmitting 210 intermediate results from a layer, O₁, or from an operator, O₁, of the neural network to a subsequent layer, O₂, or to a subsequent operator, O₂, of the neural network through an interbuffer. Alternatively or additionally, the computation graph 21 comprises temporarily storing 211 intermediate results within a layer, O₂, of the neural network in an intrabuffer for subsequent use in the same layer O₂.

FIG. 1 also outlines the case in which, in a sub-step 301 of method step 300, intermediate results which are not to be included in the memory planning but are to be stored dynamically on the stack are ascertained first. In sub-step 302, the plurality of predetermined memory planning algorithms A1, A2, A3 are then executed taking into account only the intermediate results not to be stored on the stack.

According to FIG. 1, the program code in the target language is furthermore converted into executable program code 7 in step 700. In step 800, said executable program code 7 can then be executed on at least one computer and/or on at least one compute instance so that at least one input of the neural network is converted into at least one output of the neural network.

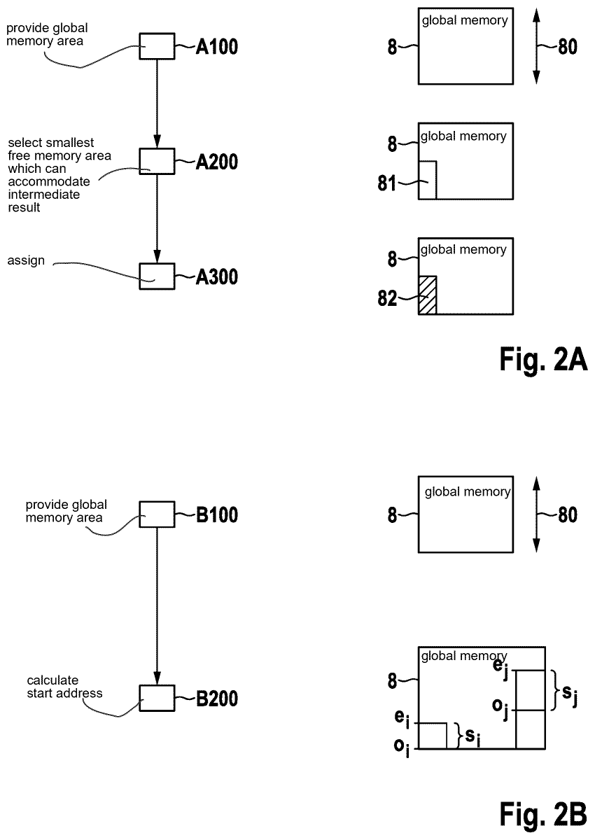

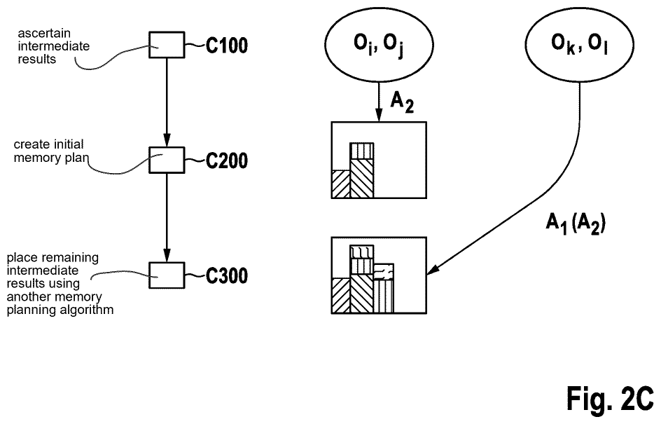

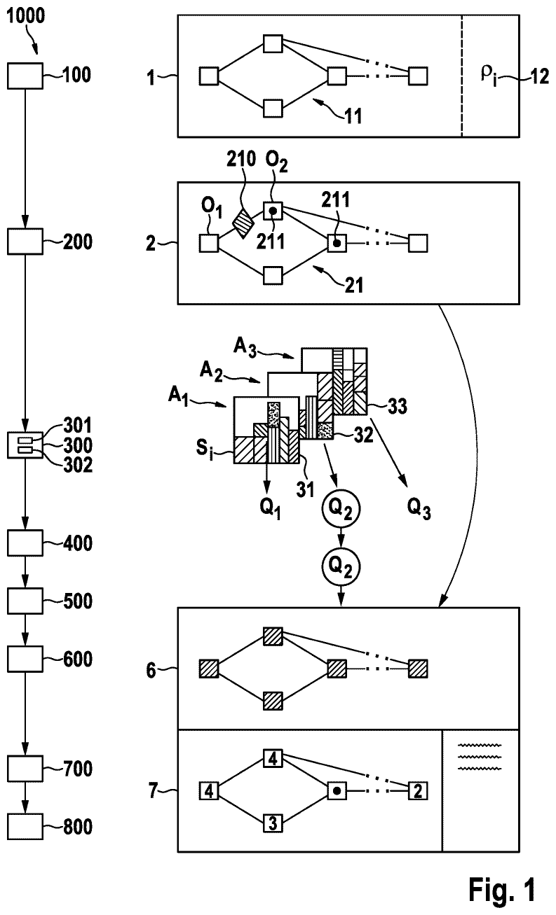

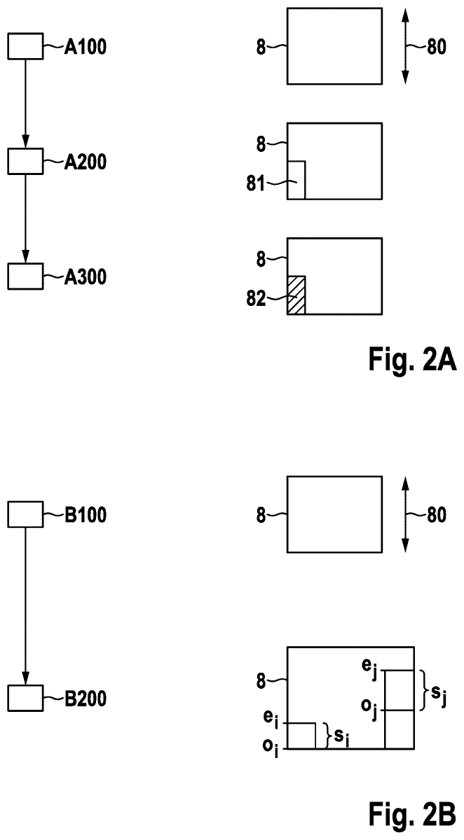

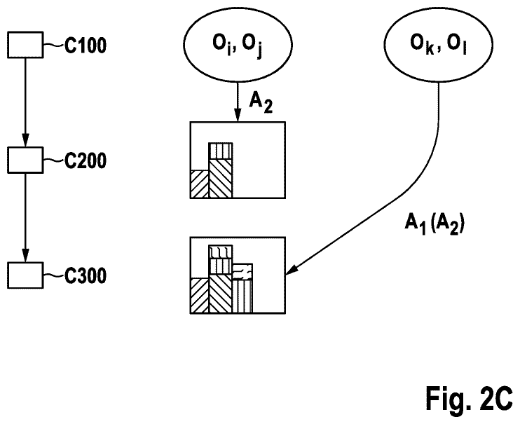

FIG. 2A relates to steps which can be carried out in a method 1000, described above by way of example, in connection with at least one of the algorithms A1, A2, A3. Accordingly, one of the algorithms, A1, of the plurality of predetermined memory planning algorithms A1, A2, A3 can comprise at least the steps outlined in FIG. 2A. In step A100, a global memory area 8 having a predetermined size 80 which corresponds at least to MaxLB is provided. As already noted above, MaxLB corresponds to the combined memory requirement of all intermediate results whose simultaneous retention is the maximum still necessary at the time of execution of an operator. In step A200, for each intermediate result, the smallest free memory area 81 within the global memory area 80 which can accommodate the intermediate result and is available for the necessary retention time of the intermediate result is then selected. In step A300, said smallest free memory area 81 is assigned to the intermediate result 82 for the necessary retention time. If this trivial memory planning algorithm fails, other heuristics are used.

FIG. 2B relates to steps within an algorithm, A2, of the plurality of predetermined algorithms in the method 1000. The relevant algorithm comprises the optimization of N start addresses oᵢ, i=1, . . . , N, for intermediate results by means of integer linear programming. The i-th intermediate result has a memory requirement sᵢ. In accordance with said memory requirement sᵢ, said i-th intermediate result occupies a memory area in the memory between the start address oᵢ and an end address eᵢ. Furthermore, pairs (u, v) of intermediate results u and v whose simultaneous retention is necessary are stored in a conflict set C. Obviously, the memory areas occupied by said intermediate results u and v must not overlap. The optimization is then aimed at minimizing the highest resulting end address eᵢ. As part of the ascertainment of the plan proposals in step 100 of the method 1000 shown in FIG. 1, a global memory area 8 having a predetermined size 80 corresponding at least to MaxLB is provided according to FIG. 2B as step B100 in an algorithm. Again, MaxLB is given by the combined memory requirement of all intermediate results whose simultaneous retention is the maximum still necessary at the time of execution of an operator. In step B200, the relevant algorithm calculates the start addresses oi in such a way that the following equations are satisfied:

$${e}_{i} = {o}_{i} + {s}_{i} ,$$

$$0 \leq {o}_{i} \leq MaxLB - {s}_{i} ,$$

$${o}_{u} \geq {e}_{v} or {o}_{v} \geq {e}_{u} , if ( u , v ) ∈ C .$$

If the algorithm does not find a solution, the size of the global memory area can be further increased to a value between MaxLB and 2*MaxLB and the optimization can be repeated using this value.

FIG. 2C shows steps within one algorithm, A3, of the plurality of predetermined memory planning algorithms A1, A2, A3, which steps can be carried out as part of the ascertainment of memory plans in method step 300 of the method 1000. In step C100, the algorithm A3 first ascertains the intermediate results which must be kept in the memory at the same time and which will require the most memory space in total. Alternatively or additionally, in this step C100, the layers O₁, O₂ of the neural network whose computation requires the most memory space for intermediate results are ascertained. These are obviously the “most voluminous” intermediate results or the intermediate results in the layer having the greatest memory requirements. Subsequently, in step C200, an initial memory plan is created for these intermediate results, without taking into account the other intermediate results. For example, an algorithm A1 or A2 can be used, the memory planning steps of which are outlined (at least partially) in FIG. 2A or 2B. In step C300, the remaining intermediate results, which were not yet included in the memory planning in step C200, are then placed using another memory planning algorithm. For placing the remaining intermediate results, an algorithm A1 or A2 can again be used, whose memory planning steps are outlined (at least partially) in FIG. 2A or 2B.

For debugging purposes, the plan proposals can also be ascertained under the additional boundary condition that a memory area once assigned for an intermediate result is not reused for another intermediate result.

1-17 (canceled)

18. A method for transforming an abstract representation of a trained neural network into program code in a target language, the program code being convertible into executable program code using a compiler for the target language, the method comprising the following steps:
reading an abstract representation of a neural network which has already been trained, wherein the abstract representation including at least an architecture of the neural network and parameters which are obtained from the training process and which characterize a behavior of the neural network;
calculating an intermediate representation of the neural network from the abstract representation, wherein the intermediate representation specifies a computation graph for output of the neural network;
ascertaining a plurality of plan proposals for planning the memory usage during execution of the computation graph, wherein the plan proposals assign an address within a predetermined, allocated memory of a terminal device to each buffer provided in the structure of the neural network;
ascertaining a quality level for each plan proposal using at least one specified criterion, wherein the quality level is a measure of a maximum total memory requirement during the execution of the computation graph, wherein a lowest possible total memory volume should be used for all buffers;
selecting a plan proposal from the plurality of plan proposals based on the ascertained quality levels; and
generating the program code in the target language from the intermediate representation and the selected plan proposal.

19. The method according to claim 18, wherein the plan proposals are ascertained using a plurality of different predetermined memory planning algorithms and/or using a parameterized approach with a plurality of different values of the free parameters.

20. The method according to claim 18, wherein at least one plan proposal includes dynamically assigning memory space for intermediate results arising during the execution of the computation graph, and subsequently releasing the assigned memory space.

21. The method according to claim 18, wherein the quality level is a measure of the maximum total memory space requirement and optionally of the program runtime depending on a number of dynamically placed buffers during the execution of the computation graph.

22. The method according to claim 18, wherein the computation graph of the neural network includes:
transmitting intermediate results from a layer, or from an operator, of the neural network to a subsequent layer, or to a subsequent operator, of the neural network through an interbuffer, and/or
temporarily storing the intermediate results within a layer f the neural network in an intrabuffer for subsequent use in the same layer.

23. The method according to claim 19, wherein one of the algorithms of the plurality of predetermined memory planning algorithms includes the following steps:
providing a global memory area having a predetermined size which corresponds at least to MaxLB, wherein MaxLB corresponds to a combined memory requirement of all intermediate results whose simultaneous retention is still necessary at the time of execution of an operator;
selecting, for each intermediate result, a smallest free memory area within the global memory area which can accommodate the intermediate result and is available for a necessary retention time of the intermediate result; and
assigning the smallest free memory area to the intermediate result for the necessary retention time.

24. The method according to claim 19, wherein one of the algorithms of the plurality of predetermined algorithms includes an optimization of N start addresses oᵢ, i=1, . . . , N, for intermediate results using integer linear programming, wherein
the i-th intermediate result has a memory requirement sᵢ and, in accordance with said memory requirement sᵢ, occupies a memory area in the memory between the start address oᵢ and an end address eᵢ,
pairs (u, v) of intermediate results u and v whose simultaneous retention is necessary are stored in a conflict set C,
the memory areas occupied by the intermediate results u and v must not overlap, and
the optimization is aimed at minimizing a highest resulting end address eᵢ.

25. The method according to claim 24, further comprising the following steps:
providing a global memory area having a predetermined size which corresponds at least to MaxLB, wherein MaxLB corresponds to a combined memory requirement of all intermediate results whose simultaneous retention is the maximum still necessary at the time of execution of an operator, and
optimizing (B200) the start addresses oᵢ using the following equations:
$${e}_{i} = {o}_{i} + {s}_{i} ,$$
$$0 \leq {o}_{i} \leq MaxLB - {s}_{i} ,$$
$${o}_{u} \geq {e}_{v} or {o}_{v} \geq {e}_{u} , if ( u , v ) ∈ C .$$

26. The method according to claim 24, wherein, in response to the optimization not leading to a solution, a size of the global memory area is increased to a value between MaxLB and 2*MaxLB.

27. The method according to claim 19, wherein one of the algorithms of the plurality of predetermined memory planning algorithms includes the following steps:
ascertaining the intermediate results which are expected to require the most memory space and/or layers of the neural network whose computation is expected to require the most memory space for intermediate results,
creating an initial memory plan for the ascertained intermediate results without taking into account the other intermediate results, and
placing remaining intermediate results using another memory planning algorithm.

28. The method according to claim 27, wherein one of the algorithms of the plurality of predetermined memory planning algorithms includes the following steps:
providing a global memory area having a predetermined size which corresponds at least to MaxLB, wherein MaxLB corresponds to a combined memory requirement of all intermediate results whose simultaneous retention is still necessary at the time of execution of an operator,
selecting, for each intermediate result, a smallest free memory area within the global memory area which can accommodate the intermediate result and is available for a necessary retention time of the intermediate result, and
assigning the smallest free memory area to the intermediate result for the necessary retention time; and
wherein the one of the algorithms is selected for creating an initial memory plan and/or for placing remaining intermediate results.

29. The method according to claim 19, further comprising the following steps:
selecting intermediate results which are not to be included in the memory planning but are to be dynamically stored on a stack, and
executing the plurality of predetermined memory planning algorithms taking into account only the intermediate results not to be stored on the stack.

30. The method according to claim 18, wherein, for debugging purposes, the plan proposals are ascertained under an additional boundary condition that a memory area once assigned for an intermediate result is not reused for another intermediate result.

31. The method according to claim 18, further comprising:
converting the program code in the target language into executable program code; and
executing the executable program code on at least one computer and/or on at least one compute instance so that at least one input of the neural network is converted into at least one output of the neural network.

32. A non-transitory machine-readable data carrier on which is stored a computer program including machine-readable instructions for transforming an abstract representation of a trained neural network into program code in a target language, the program code being convertible into executable program code using a compiler for the target language, the instructions when executed by one or more computers and/or computer instances, causing the one or more computers and/or computer instances to perform the following steps:
reading an abstract representation of a neural network which has already been trained, wherein the abstract representation including at least an architecture of the neural network and parameters which are obtained from the training process and which characterize a behavior of the neural network;
calculating an intermediate representation of the neural network from the abstract representation, wherein the intermediate representation specifies a computation graph for output of the neural network;
ascertaining a plurality of plan proposals for planning the memory usage during execution of the computation graph, wherein the plan proposals assign an address within a predetermined, allocated memory of a terminal device to each buffer provided in the structure of the neural network;
ascertaining a quality level for each plan proposal using at least one specified criterion, wherein the quality level is a measure of a maximum total memory requirement during the execution of the computation graph, wherein a lowest possible total memory volume should be used for all buffers;
selecting a plan proposal from the plurality of plan proposals based on the ascertained quality levels; and
generating the program code in the target language from the intermediate representation and the selected plan proposal.

33. One or more computers and/or compute instances equipped a non-transitory machine-readable data carrier on which is stored a computer program including machine-readable instructions for transforming an abstract representation of a trained neural network into program code in a target language, the program code being convertible into executable program code using a compiler for the target language, the instructions when executed by the one or more computers and/or computer instances, causing the one or more computers and/or computer instances to perform the following steps:
reading an abstract representation of a neural network which has already been trained, wherein the abstract representation including at least an architecture of the neural network and parameters which are obtained from the training process and which characterize a behavior of the neural network;
calculating an intermediate representation of the neural network from the abstract representation, wherein the intermediate representation specifies a computation graph for output of the neural network;
ascertaining a plurality of plan proposals for planning the memory usage during execution of the computation graph, wherein the plan proposals assign an address within a predetermined, allocated memory of a terminal device to each buffer provided in the structure of the neural network;
ascertaining a quality level for each plan proposal using at least one specified criterion, wherein the quality level is a measure of a maximum total memory requirement during the execution of the computation graph, wherein a lowest possible total memory volume should be used for all buffers;
selecting a plan proposal from the plurality of plan proposals based on the ascertained quality levels; and
generating the program code in the target language from the intermediate representation and the selected plan proposal.
